(19) United States
(12) Patent Application Publication
(10) Pub. No.: US 2016/0141826 A1
(43) Pub. Date: May 19, 2016

(54) LIQUID CLADDING FOR MULTIPLE CLAD FIBER LASER

(71) Applicant: BAE Systems Information & Electronic Systems Integration Inc., Nashua, NH (US)

(72) Inventor: Benjamin R. Johnson, Nottingham, NH (US)

(73) Assignee: BAE Systems Information And Electronic Systems Integration Inc.

(21) Appl. No.: 14/939,042

(22) Filed: Nov. 12, 2015

Related U.S. Application Data
(60) Provisional application No. 62/079,192, filed on Nov. 13, 2014.

(51) Int. Cl. H01S 3/067; H01S 3/04; H01S 3/094; G02B 6/032; G02B 6/036

(52) U.S. Cl. CPC H01S 3/06733; G02B 6/032; G02B 6/03694; H01S 3/06754; H01S 3/094042; H01S 3/0407; G02B 2006/0325

(57) ABSTRACT

A laser system comprising a double clad or multiple clad fiber laser and methods of use are provided. The fiber laser may include a liquid cladding layer, which may be used to facilitate heat exchange. The liquid may be contained in a jacket and may be pumped out of the jacket as part of the heat exchange process. The liquid cladding layer may be used as a wave guide or an anti-wave guide.

### CROSS-REFERENCE TO RELATED APPLICATION

This application claims priority from U.S. Provisional Patent Application Ser. No. 62/079,192, filed Nov. 13, 2014, the disclosure of which is incorporated herein by reference.

### BACKGROUND

1. Technical Field

The technical field may relate to lasers and more particularly to multiple clad fiber lasers having a liquid cladding layer.

2. Background Information

Double clad fiber laser technology in the 1 μm (micometer or micron) region has progressed immensely, partially as a result of the low absorption of silica and the use of cladding-pumping. Cladding-pumping may be achieved with an optical fiber having a glass cladding which is coated with a low-index polymer that guides pump radiation in the glass cladding. Low absorption of cladding radiation in the polymer and glass cladding is critical for efficient cladding pumped operation of a fiber laser.

The highest power 1 μm fiber lasers (e.g., >10 kW) use resonant pumping of ytterbium-doped fiber (YDF). Resonant pumping is an efficient method to reach very-high-power fiber lasers in the 1 μm region using YDF since silica and polymer losses are nearly negligible in the 1 μm region. Resonant-pumping double-clad thulium and holmium-doped fibers may be a viable path to efficient, very-high-power fiber lasers generally in the 2 μm spectral region. However, current fiber optic cladding technology has generally impeded progress towards efficient, compact, very-high-power fiber lasers for wavelengths which are greater than 1.8 or 2.0 μm.

For example, current double-clad technology falls short of satisfying the optical and mechanical requirements of double-clad fiber lasers operating at wavelengths (λ) greater than 1800 nanometers (nm) or 1.8 μm. Sufficient transparency of laser materials for λ>1800 nm is critical for efficient operation of associated lasers, such as resonantly-pumped double-clad thulium fiber lasers or a cladding pumped holmium fiber laser using a thulium fiber laser. Resonantly pumped, double-clad fiber lasers operating in wavelengths greater than 1800 nm generally require pump wavelengths near that wavelength region, which is a high absorption region of silica and polymer coatings. Thus, for instance, using a thulium-doped fiber (TDF) at 1910 nm to optically pump a TDF at 2050 nm suffers from prohibitive cladding losses in polymer claddings, and modest losses in glass claddings.

There is an inability in prior art polymer cladding technology in fiber optics to provide sufficient optical and mechanical performance for high-power fiber lasers operating in the >2 μm regime. Current polymers and optical gels for use in creating a cladding waveguide in optical fibers were developed for pump wavelengths in the visible-near-infrared (IR) region. Less effort has been devoted to lowering loss for wavelengths >1800 nm. For cladding-pumped double-clad fiber lasers using pump wavelengths >1800 nm, this is a significant barrier to efficient laser operation. As the pump radiation propagates, it is absorbed by the polymer cladding instead of the active-ion doped core. This obviously prevents the ions from reaching sufficient inversion and achieving high laser efficiency.

Although “triple-clad” fibers have been developed that use a second cladding of glass to solve the issue of pump absorption in the polymer cladding, the complexity of the fiber optic design using glass claddings limits the brightness capabilities of a laser. Additionally, the extra glass cladding and accompanying polymer coating present extra thermal resistances between the heat-generating core and a thermal sink. Silica, the material that fiber optics are primarily composed of, introduces additional limitations because its transparency decreases for wavelengths >1800 nm. Such limitations have precluded development a high-power fiber optic laser using triple-clad fibers in the >1800 nm region at the pinnacle of operation.

### SUMMARY

In one aspect, a laser system may comprise an optical fiber comprising a rare earth doped core, at least one solid cladding layer, a liquid cladding layer which is formed of a liquid and which extends around and is in contact with the at least one solid cladding layer, and a jacket defining an interior chamber which contains the liquid cladding layer.

In another aspect, a method may comprise the steps of providing an optical fiber comprising a rare earth doped core, at least one solid cladding layer, a liquid cladding layer which is formed of a liquid and which extends around and is in contact with the at least one solid cladding layer, and a jacket defining an interior chamber which contains the liquid cladding layer; and pumping pump light into the at least one solid cladding layer.

### BRIEF DESCRIPTION OF THE SEVERAL VIEWS OF THE DRAWINGS

One or more sample embodiments are set forth in the following description, shown in the drawings and particularly and distinctly pointed out and set forth in the appended claims.

FIG. 1 is a schematic view of a laser system including a double clad or multiple clad fiber laser having a “low index” liquid cladding layer.

FIG. 2 is a schematic view of a laser system using the fiber laser of FIG. 1 in a fiber laser oscillator.

FIG. 3 is a schematic view of a laser system including a double clad or multiple clad fiber laser having a “high index” liquid cladding layer.

Similar numbers refer to similar parts throughout the drawings.

### DETAILED DESCRIPTION

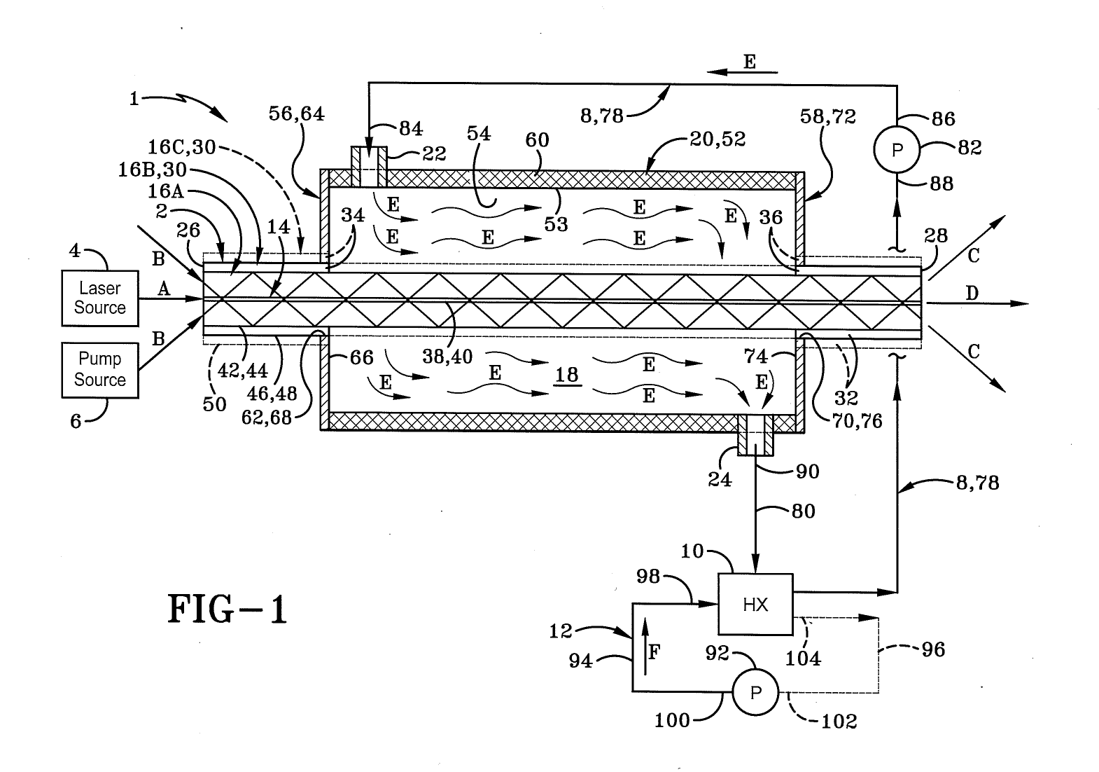

FIG. 1 generally shows a laser system 1 which may comprise a double clad or multiple clad rare earth doped medium or optical fiber or optical fiber piece 2, a laser source 4, an optical pump source 6, a first closed circulation loop 8, a heat exchanger (HX) 10, and a liquid or gas flow path 12 (which may be an airflow path), which may be a second closed circulation loop.

Optical fiber 2 may include a gain medium or core 14, one or more solid cladding layers 16 (such as layers 16A, 16B and 16C) and a liquid cladding layer 18 formed of a liquid (also represented by 18). Core 14 and cladding layers 16 and 18 may be formed of highly transparent materials (discussed further below). Liquid cladding layer 18 may be contained by a jacket 20 which may have an inlet 22 and an outlet 24 which may allow liquid 18 to flow into and out of jacket 20, or may be formed as a sealed or closed jacket or container which does not include an inlet or outlet, as indicated by dashed lines in the area of inlet 22 and outlet 24, in which case liquid 18 is essentially static or trapped within jacket 20. Optical fiber piece 2 may have an upstream end 26 and a downstream end 28. Core 14 and one or more of cladding layers 16A-C may extend continuously from end 26 to end 28 although layers 16B or 16C might not, but may rather be formed as segments upstream of and downstream of jacket 20. For instance, layer 16B or 16C may include a first or upstream segment 30 upstream of jacket 20 and a first or downstream segment 32 downstream of jacket 20 and segment 30. Upstream segment 30 may have a downstream end 34, and downstream segment 32 may have an upstream end 36. Ends 26 and 28 may respectively represent the upstream and downstream ends of core 14 and layers 16 such that end 26 may represent the upstream end of segments 30 of layers 16B and 16C, and end 28 may represent the downstream end of segments 32 of layers 16B and 16C.

Core 14 may have an outer perimeter 38 which extends from the upstream end 26 thereof to the downstream end 28 thereof. Solid cladding layer 16A may have an inner perimeter 40 and an outer perimeter 42 each of which extends from the upstream end 26 thereof to the downstream end 28 thereof. Each of upstream and downstream segments 30 and 32 of solid cladding layer 16B may have an inner perimeter 44 and an outer perimeter 46. Inner and outer perimeters 44 and 46 of layer 16B upstream segment 30 may extend from the upstream end 26 thereof to the downstream end 34 thereof. Inner and outer perimeters 44 and 46 of layer 16B downstream segment 32 may extend from the upstream end 36 thereof to the downstream end 28 thereof. Each of upstream and downstream segments 30 and 32 of solid cladding layer 16C (dashed lines) may have an inner perimeter 48 and an outer perimeter 50. Inner and outer perimeters 48 and 50 of layer 16C upstream segment 30 may extend from the upstream end 26 thereof to the downstream end 34 thereof. Inner and outer perimeters 48 and 50 of layer 16C downstream segment 32 may extend from the upstream end 36 thereof to the downstream end 28 thereof.

Gain medium or core 14 is embedded within the one or more solid cladding layers (e.g., layers 16A-C). An outer coating such as a polymer coating (not shown) may coat the one or more cladding layers. Gain medium or core 14 may be formed of or comprise one or more of a silica-based glass, a fluoride-based glass, a chalcogenide-based glass, a telluride-based glass, and an yttria-based glass which is doped with one or more of the rare earth elements ytterbium, neodymium, erbium, praseodymium, thulium and holmium. Solid cladding layers 16A-C may be formed of glass or various transparent polymers known in the art. Liquid 18 may be one of many different transparent optical fluids. Such optical fluids are produced, for example, by Cargille Laboratories of Cedar Grove, N.J., which offers optical fluids with a wide range of indices of refraction and various transparency ranges. Other common fluids may also be used, such as water, vegetable oils, petroleum distillates, hydrocarbon solvents and other immersion oils such as used in microscopy.

Core 14 may be embedded in solid cladding layer 16A so that outer perimeter 38 may be in contact with inner perimeter 40 of layer 16A at an interface therebetween in a continuous manner from end 26 to end 28 along the entirety of perimeters 38 and 40. Layer 16A may be embedded in each of solid cladding layer 16B segments 30 and 32. Outer perimeter 42 of layer 16A may be in contact with inner perimeter 44 of layer 16B upstream segment 30 at an interface therebetween in a continuous manner from upstream end 26 to downstream end 34 of layer 16B segment 30 along the entirety of perimeter 44 of layer 16B segment 30. Outer perimeter 42 of layer 16A may be in contact with inner perimeter 44 of layer 16B downstream segment 32 at an interface therebetween in a continuous manner from upstream end 36 of layer 16B segment 32 to downstream end 28 along the entirety of perimeter 44 of layer 16B segment 32. Layer 16B segments 30 and 32 may be embedded respectively in solid cladding layer 16C segments 30 and 32. Outer perimeter 46 of layer 16B upstream segment 30 may be in contact with inner perimeter 48 of layer 16C upstream segment 30 at an interface therebetween in a continuous manner from upstream end 26 of segments 30 of layers 16B and 16C to downstream end 34 of segments 30 of layers 16B and 16C along the entirety of perimeter 46 of layer 16B segment 30 and perimeter 48 of layer 16C segment 30. Outer perimeter 46 of layer 16B downstream segment 32 may be in contact with inner perimeter 48 of layer 16C downstream segment 32 at an interface therebetween in a continuous manner from upstream end 36 of segments 32 of layers 16B and 16C to downstream end 28 of segments 32 of layers 16B and 16C along the entirety of perimeter 46 of layer 16B segment 32 and perimeter 48 of layer 16C segment 32.

Jacket 20 may have a chamber wall or jacket wall 52 having an inner surface which defines an interior chamber 54 which contains liquid cladding layer 18. Each of inlet 22 and outlet 24 may be in fluid communication with interior chamber 54. Wall 52 may include a first or upstream end wall 56, a second or downstream end wall 58 and a sidewall 60 which may be secured to and extend between end walls 56 and 58. End wall 56 may define a hole 62 which extends from an outer surface 64 of wall 56 to an inner surface 66 of wall 56 and which may be defined by an inner perimeter 68 of wall 56. End wall 58 may define hole 70 which extends from an outer surface 72 of wall 58 to an inner surface 74 of wall 56 and which may be defined by an inner perimeter 76 of wall 58.

This paragraph describes various relationships where cladding layer 16B segments 30 and 32 are used (i.e. without cladding layer 16C). Inner perimeter 68 may be closely adjacent or in contact with outer perimeter 46 of cladding layer 16B segment 30 and extend radially outward therefrom. Downstream end 34 of cladding layer 16B segment 30 may be adjacent hole 62 and adjacent or flush with inner surface 66 of end wall 56. Segment 30 of layer 16B may extend upstream from adjacent hole 62 and end wall 56. Inner perimeter 76 may be closely adjacent or in contact with outer perimeter 46 of cladding layer 16B segment 32 and extend radially outward therefrom. Upstream end 36 of cladding layer 16B segment 32 may be adjacent hole 70 and adjacent or flush with inner surface 74 of end wall 58. Segment 32 of layer 16B may extend downstream from adjacent hole 70 and end wall 58. Core 14, cladding layer 16A and cladding layer 16B upstream segment 30 may extend within or through hole 62 so that a portion of each core 14, layer 16A and layer 16B segment may be upstream of hole 62 and end wall 56 external to or outside interior chamber 54/jacket 20; a portion of each of core 14, layer 16A and layer 16B segment 30 may extend within hole 62; and a portion of each of core 14, layer 16A and layer 16B segment 30 may extend downstream of hole 62 and end wall 56 inside interior chamber 54/jacket 20, although layer 16B segment 30 may terminate at inner surface 66 or within hole 62 so that no portion of layer 16B segment 30 extends inside chamber 54 (i.e. inwardly or downstream beyond inner surface 66). Segments 30 and 32 of layers 16B may be referred to as external segments which extend outside jacket 20/interior chamber 54. Similarly, each of core 14 and layer 16A may have external segments which extend outside jacket 20/chamber 54 upstream and downstream thereof, as well as internal segments which extend within jacket 20/chamber 54. Liquid 18 may completely fill interior chamber 54 so that liquid cladding layer 18 extends from downstream inner surface 66 of end wall 56 to upstream inner surface 74 of end wall 58 and from inner surface 53 of sidewall 60 to the outer perimeter of the outermost of the solid cladding layers 16 inside jacket interior chamber 54, in this case, outer perimeter 42 of layer 16A. The portion of core 14 and layer 16A inside chamber 54 may extend continuously from inner surface 66 of end wall 56 to inner surface 74 of end wall 58. Outer perimeter 42 of the portion of layer 16A inside chamber 54 may be exposed (i.e., not covered by a solid layer such as layer 16B inside chamber 54) from adjacent inner surface 66 of end wall 58 to adjacent inner surface 74 of end wall 58. Thus, liquid layer 18 along its inner perimeter may be in continuous contact with this exposed portion of outer perimeter 42 of the portion of layer 16A inside chamber 54 from adjacent inner surface 66 of end wall 58 to adjacent inner surface 74 of end wall 58.

This paragraph describes various relationships where cladding layer 16C segments 30 and 32 are used such that layer 16B extends continuously from end 26 to end 28. Inner perimeter 68 may be closely adjacent or in contact with outer perimeter 50 of cladding layer 16C segment 30 and extend radially outward therefrom. Downstream end 34 of cladding layer 16C segment 30 may be adjacent hole 62 and adjacent or flush with inner surface 66 of end wall 56. Segment 30 of layer 16C may extend upstream from adjacent hole 62 and end wall 56. Inner perimeter 76 may be closely adjacent or in contact with outer perimeter 50 of cladding layer 16C segment 32 and extend radially outward therefrom. Upstream end 36 of cladding layer 16C segment 32 may be adjacent hole 70 and adjacent or flush with inner surface 74 of end wall 58. Segment 32 of layer 16C may extend downstream from adjacent hole 70 and end wall 58. Core 14, cladding layers 16A and 16B, and cladding layer 16C upstream segment 30 may extend within or through hole 62 so that a portion of each core 14, layers 16A and 16B and layer 16C segment 30 may be upstream of hole 62 and end wall 56 external to or outside interior chamber 54/jacket 20; a portion of each of core 14, layers 16A and 16B and layer 16C segment 30 may extend within hole 62; and a portion of each of core 14, layers 16A and 16B and layer 160 segment 30 may extend downstream of hole 62 and end wall 56 inside interior chamber 54/jacket 20, although layer 16C segment 30 may terminate at inner surface 66 or within hole 62 so that no portion of layer 16C segment 30 extends inside chamber 54 (i.e. inwardly or downstream beyond inner surface 66). Segments 30 and 32 of layers 16C may be referred to as external segments which extend outside jacket 20/interior chamber 54. Similarly, each of core 14 and layer 16A and 16B may each have external segments which extend outside jacket 20/chamber 54 upstream and downstream thereof, as well as internal segments which extend within jacket 20/chamber 54. Liquid 18 may completely fill interior chamber 54 so that liquid cladding layer 18 extends from downstream inner surface 66 of end wall 56 to upstream inner surface 74 of end wall 58 and from inner surface 53 of sidewall 60 to the outer perimeter of the outermost of the solid cladding layers 16 inside jacket interior chamber 54, in this case, outer perimeter 46 of layer 16B. The portion of core 14 and layers 16A and 16B inside chamber 54 may extend continuously from inner surface 66 of end wall 56 to inner surface 74 of end wall 58. Outer perimeter 46 of the portion of layer 16B inside chamber 54 may be exposed (i.e., not covered by a solid layer such as layer 16C inside chamber 54) from adjacent inner surface 66 of end wall 58 to adjacent inner surface 74 of end wall 58. Thus, liquid layer 18 along its inner perimeter may be in continuous contact with this exposed portion of outer perimeter 46 of the portion of layer 16B inside chamber 54 from adjacent inner surface 66 of end wall 58 to adjacent inner surface 74 of end wall 58.

Core 14 may have a refractive index and cladding layer 16A may have a refractive index which is less than or lower than the refractive index of core 14. Cladding layer 16B may have a refractive index which is less than or lower than the refractive index of cladding layer 16A and core 14. Cladding layer 16C may have a refractive index which is less than or lower than the refractive index of cladding layer 16B, cladding layer 16A and core 14. Liquid cladding layer 18 may have a refractive index which is less than or lower than the refractive index of cladding layers 16A-C and core 14, whereby layer 18 may serve as a waveguide for wave guiding light or radiation which propagates within the outermost of the solid layers 16 inside chamber 54. Thus, of the core 14 and the cladding layers 16 and 18 which are used in optical fiber 2, core 14 may have the highest refractive index and liquid cladding layer 18 may have the lowest refractive index, and the refractive indexes or indices of the cladding layers 16 and 18 may be sequentially less or lower as one moves radially outward further from core 14.

Thus, liquid cladding layer 18 may have a refractive index which is less than or lower than the refractive index of the solid cladding layer 16 which is the outermost of the solid cladding layers 16 of optical fiber 2 which is inside interior chamber 54/jacket 20 so that the outer perimeter of the outermost layer 16 inside interior chamber 54/jacket 20 is in contact with liquid cladding layer 18. Thus, for instance, where optical fiber 2 includes layer 16A extending inside interior chamber 54/jacket 20 and outside (upstream and downstream) of interior chamber 54/jacket 20, and includes layer 16B with layer 16B segment 30 upstream of and outside interior chamber 54/jacket 20 and layer 16B segment 32 downstream of and outside interior chamber 54/jacket 20, liquid cladding layer 18 is in contact with outer perimeter 42 of layer 16A and has a refractive index which is lower than the refractive index of layer 16A. By way of further example, where optical fiber 2 includes layers 16A and 16B extending inside interior chamber 54/jacket 20 and outside (upstream and downstream) of interior chamber 54/jacket 20, and includes layer 16C with layer 16C segment 30 upstream of and outside interior chamber 54/jacket 20 and layer 16C segment 32 downstream of and outside interior chamber 54/jacket 20, liquid cladding layer 18 is in contact with outer perimeter 46 of layer 16B and has a refractive index which is lower than the refractive index of layer 16B. It will be understood that layer 16C may be embedded in an additional solid cladding layer having upstream and downstream segments analogous to segments 30 and 32 so that layer 16C could extend inside chamber 54/jacket 20 so that this additional layer would be the outermost of the solid cladding layers and the outer perimeter 50 of layer 16C could be in contact with liquid 18.

Circulation loop 8 may include interior chamber 54, a jacket feed line or conduit 78, a jacket discharge line or conduit 80 and a pump 82. Feed line 78 may have a downstream end 84 connected to jacket inlet 22 and an upstream end 86 connected to an outlet of pump 82. Discharge line 80 may have a downstream end 88 connected to an inlet of pump 82 and an upstream end 90 connected to jacket outlet 24. Via these various connections, interior chamber 54, inlet 22, outlet 24, feed line 78, discharge line 80 and pump 82 may be in fluid communication with one another so that liquid 18 may move downstream through each of these components, as when pump 82 is operated to that effect.

Heat exchanger 10 may be external to or outside jacket 20 and adjacent circulation loop 8. HX 10 may be, for instance, a shell and tube heat exchanger, a plate heat exchanger, a plate fin heat exchanger, or any suitable type of heat exchanger to facilitate heat exchange between liquid 18 and the atmosphere within and around HX 10, including a cooling air, gas or liquid moving within or along liquid flow/gas flow path 12. Path or loop 12 may include a pump, fan or blower 92 and a portion of HX 10. Loop 12 may include a heat exchanger feed line or conduit 94 and a heat exchanger discharge line or conduit 96. Feed line 94 may have a downstream end 98 connected to a heat exchanger inlet of HX 10 and an upstream end 100 connected to an outlet of pump 92. Discharge line 96 may have a downstream end 102 connected to an inlet of pump 92 and an upstream end 104 connected to a heat exchanger outlet of HX 10. Feed line 94 and discharge line 96 may be separate line or conduit segments or they may be a single line or conduit which passes through or adjacent HX 10. Via these various connections, HX 10, feed line 94, discharge line 96 and pump/blower 92 may be in fluid communication with one another so that a cooling liquid or gas (e.g., air) may move downstream through some or all of these components, as when pump/blower 92 is operated to that effect.

While a cooling liquid or gas may be circulated through loop 12, it will be understood that especially where air or another gas is used as a cooling gas that component 92 may be a fan or blower which blows the cooling gas along or through flow path 12/94 without necessarily being circulated or recirculated through a discharge line such as line 96 back to the blower 92, whereby line 96 might not be used and is thus shown in dashed lines. Thus, air or another gas may be blown or moved along a conduit/duct or an open path 12/94 adjacent and past HX 10 to absorb heat from liquid 18 and move the heat away from liquid 18 and HX 10.

Laser source 4 may be any suitable laser source known in the art which is configured to produce a laser and seed optical fiber 2/core 14 so that the seed laser may enter core 14 via upstream end 26 thereof and propagate or move downstream through core 14 from upstream end 26 to and out of downstream end 28. Optical pump source/light source 6 may include one or more optical pump sources or light sources 6. Pump source 6 may, for example, be in the form of a discharge lamp (arc lamp, flash lamp) or a pump diode. Optical pump/light source 6 may seed optical fiber 2/various cladding layers so that the pump light may enter one or more of cladding layers (e.g., 16A, 16B) via upstream ends 26 thereof and propagate or move downstream therethrough from upstream end 26 to and out of downstream end 28.

The operation of laser system 1 is now described for the scenario in which optical fiber 2 includes core 14, cladding layer 16A and cladding layer 16B segments 30 and 32. Laser source 4 may produce a seed laser (Arrow A) which exits laser source 4 and enters upstream end 26 of core 14 and travels downstream through core 14 to and out of downstream end 28 of core 14. Meanwhile, pump source(s) 6 may produce pump light which, as represented at Arrows B, exits pump source 6 and may enter upstream end 26 of cladding layer 16A and travel downstream through layer 16A so that a portion of the pump light is absorbed in the gain medium or core 14 to amplify the seed laser (Arrow A) and an unabsorbed or unused portion of the pump light which is not absorbed by the core 14 continues traveling downstream through layer 16A and exits downstream end 28 of layer 16A, as indicated at Arrows C. The amplified laser exiting the downstream end 28 of core 14 is represented at Arrow D. It is noted that laser source 4 and pump source 6 may produce signals with a large variety of wavelengths, including wavelengths which are greater than 1800 nm.

As the pump light moves through cladding layer 16A, it is reflected back and forth initially upstream of jacket 20 end wall 56 at or along the guiding boundary or interface of layer 16A and layer 16B upstream segment 30 where outer perimeter 42 of layer 16A and inner perimeter 44 of 16B upstream segment 30 meet, then inside interior chamber 54/jacket 20 at or along the guiding boundary or interface of solid layer 16A and liquid layer 18 where outer perimeter 42 of layer 16A and the inner perimeter of liquid layer 18 meet, then downstream of jacket 20 end wall 58 at or along the guiding boundary or interface of layer 16A and layer 16B downstream segment 32 where outer perimeter 42 of layer 16A and inner perimeter 44 of 16B downstream segment 32 meet. Cladding fluid 18 may be selected to exhibit sufficiently low optical absorption for the wavelengths in propagation for efficient laser operation. Fluid 18 may also demonstrate stable phase-state and viscosity properties over the range of operating temperatures and pressure when in contact with the exposed solid cladding layer.

As the laser/signal radiation and pump light/radiation are propagating respectively through core 14 and cladding layer 16A, pump 82 may be operated to pump fluid 18 through loop 8, as indicated by various Arrows E. More particularly, pump 82 may pump or move fluid 18 downstream out of the pump 82 outlet into and through feed line 78, into interior chamber 54/jacket 20 through inlet 22, through chamber 54 and around all of the layer 16A outer perimeter 42 which is exposed within chamber 54, out of chamber 54 through outlet 24, and into and through discharge line 80 back to pump 82 through the inlet thereof. This circulation of fluid 18 thus allows jacket 20/liquid 18 within jacket 20 to serve as a heat exchanger in which heat is transferred primarily from the portion of optical fiber 2 inside chamber 54/jacket 20 to liquid 18, for instance, from the portion of core 14 and layer 16A inside chamber 54 to liquid 18 inside chamber 54. This heat exchange thus cools the portion of fiber 2 within chamber 54 to prevent overheating of fiber 2 and other nearby components. The heat which was transferred to liquid 18 may then be carried within the heated liquid 18 outside of chamber 54/jacket 20 as the heated liquid 18 circulates out of chamber 54. The heated liquid 18 may move into and through or adjacent HX 10 so that the heated liquid 18 may be cooled by HX 10. This cooling of heated liquid 18 may be aided by the movement of a cooling gas or a fluid (Arrow F) through or adjacent HX 10. Fan or blower 92 may blow cooling air or another gas along or through path/feed line/duct 96 or loop 12, or pump 92 may pump a cooling liquid through loop 12 to that effect. Thus, heat within heated liquid 18 may be transferred from liquid 18 in HX 10 to the cooling gas or liquid which is blown or pumped along/through path 12/feed line 96 past or through HX 10, thereby cooling liquid 18, which may then continue to flow as a cooled liquid through jacket feed line 78 back into chamber 54 to repeat the heat exchange process.

Where jacket 20 defines a closed interior chamber without inlet 22 and outlet 24, cooling fins or plates, for example, may be provided along jacket 20 to facilitate heat exchange. Such an arrangement may include, for example, blowing a cooling air or other gas along such fins or plates to facilitate heat exchange, thereby helping to cool jacket 20 and liquid 18 in chamber 54 along with core 14 and any layers 16 within chamber 54.

The operation of laser system 1 is now described for the scenario in which optical fiber 2 includes core 14, cladding layer 16A, cladding layer 16B segments 30 and 32, and cladding layer 16C segments 30 and 32. Laser source 4 may operate as described previously. Pump source(s) 6 may produce pump light which may enter upstream end 26 of cladding layer 16A and travel downstream through layer 16A in the same manner as described above.

Meanwhile and in addition, pump source(s) 6 may produce pump light which, as represented at Arrows B, exits pump source 6 and may enter upstream end 26 of cladding layer 16B and travel downstream through layer 16B so that a portion of the pump light in layer 16B may move into layer 16A and be absorbed in the gain medium or core 14 to amplify the seed laser (Arrow A), and an unabsorbed or unused portion of the pump light in layer 16B which does not move into layer 16A (and thus is not absorbed by the core 14) continues traveling downstream through layer 16B and exits downstream end 28 of layer 16B, as may also be represented by Arrows C.

As pump light moves through cladding layer 16B, it may be reflected back and forth initially upstream of jacket 20 end wall 56 at or along the boundary or interface of layer 16B and layer 16C upstream segment 30 where outer perimeter 46 of layer 16B and inner perimeter 48 of layer 16C upstream segment 30 meet, then inside interior chamber 54/jacket 20 at or along the boundary or interface of solid layer 16B and liquid layer 18 where outer perimeter 46 of layer 16B and the inner perimeter of liquid layer 18 meet, then downstream of jacket 20 end wall 58 at or along the boundary or interface of layer 16B and layer 16C downstream segment 32 where outer perimeter 46 of layer 16B and inner perimeter 48 of layer 16C downstream segment 32 meet.

The heat exchange operation may be the same as described above except that heat may be transferred from core 14, layer 16A and layer 16B via the interface between solid layer 16B and liquid layer 18. It will be understood that optical fiber 2 may include one or more additional solid cladding layers which surround layers 16A and 16B, and that analogous operation may occur in such cases.

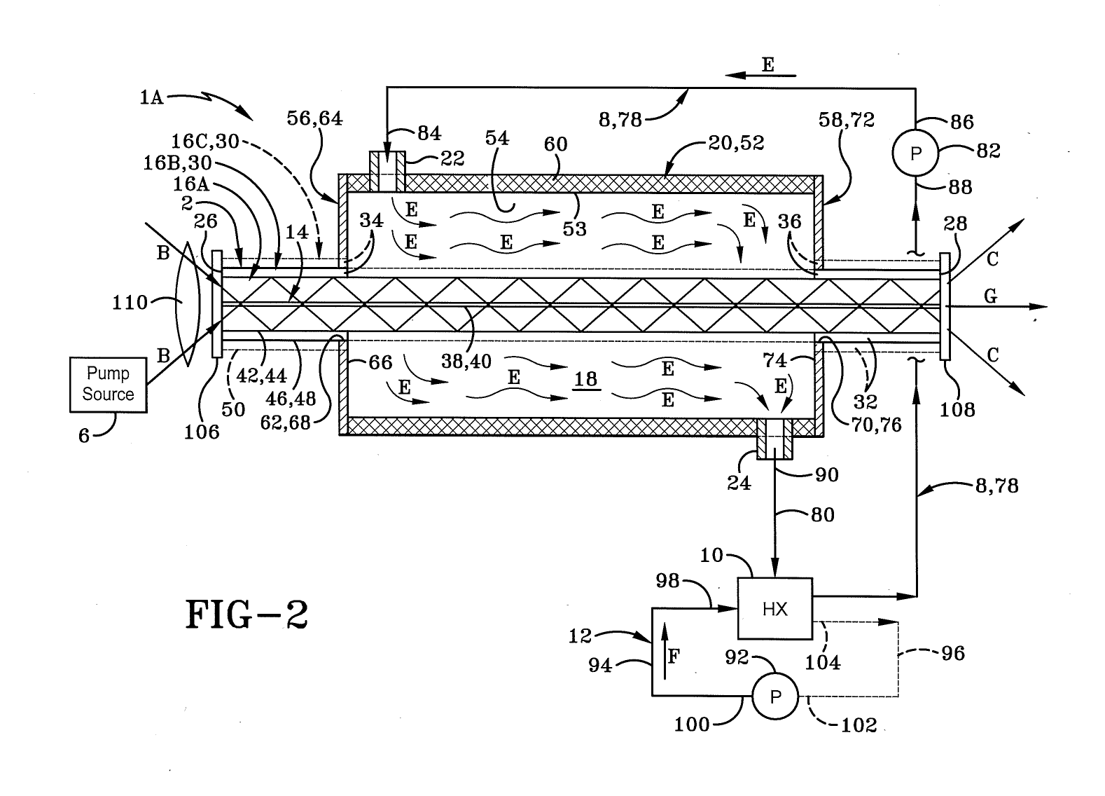

System 1A (FIG. 2) is similar to system 1 except that system 1A does not include a laser source 4 which produces a laser which seeds the optical fiber 2 as discussed above with respect to system 1. Instead, optical fiber 2 in system 1A may be part of a fiber laser oscillator which may also include a high reflector or high reflector mirror or cavity reflector 106 downstream of pump source(s) 6 and upstream of end 26 of fiber 2, and a partial reflector or partial reflector mirror or cavity reflector 10 which is downstream of fiber 2 end 28 and may serve as an oscillator output of the oscillator. System 1A may further include a coupling lens 110 downstream of pump source(s) 6 and upstream of high reflector 106. (Such a coupling lens may likewise be used in system 1 and system 1B.) Mirror 106 may be a high reflector fiber Bragg grating or other suitable high reflector known in the art. Mirror 108 may be a partial reflector fiber Bragg grating or other suitable partial reflector known in the art.

The operation of laser system 1A is now described for the scenario in which optical fiber 2 includes core 14, cladding layer 16A and cladding layer 16B segments 30 and 32. Pump source(s) 6 may produce pump light which, as represented at Arrows B, may exit pump source 6 and pass downstream through lens 110 to enter the optical cavity (a.k.a. resonant cavity or optical resonator) comprising high reflector 106, doped fiber 2 and partial reflector 108 to produce a laser (Arrow G) which exits the output/reflector 108 of the optical cavity and oscillator. More particularly, the pump light that exits pump source 6 and passes downstream through lens 110 may enter upstream end 26 of cladding layer 16A and travel downstream through layer 16A so that a portion of the pump light is absorbed in the gain medium or core 14 to produce laser G. Unused or unabsorbed pump light, which was not absorbed in the gain medium or fiber 2 of the fiber laser oscillator, also moves downstream through layer 16A to exit the output/reflector 108 of the optical cavity/oscillator (as shown at Arrows C).

As the pump light moves through cladding layer 16A, it is reflected back and forth initially upstream of jacket 20 end wall 56 at or along the boundary or interface of layer 16A and layer 16B upstream segment 30 where outer perimeter 42 of layer 16A and inner perimeter 44 of layer 16B upstream segment 30 meet, then inside interior chamber 54/jacket 20 at or along the boundary or interface of solid layer 16A and liquid layer 18 where outer perimeter 42 of layer 16A and the inner perimeter of liquid layer 18 meet, then downstream of jacket 20 end wall 58 at or along the boundary or interface of layer 16A and layer 16B downstream segment 32 where outer perimeter 42 of layer 16A and inner perimeter 44 of 16B downstream segment 32 meet.

The heat exchange operation may be the same as described above with respect to system 1 when optical fiber 2 includes core 14, cladding layer 16A and cladding layer 16B segments 30 and 32 such that outer perimeter 42 of layer 16A is exposed to liquid layer 18 inside chamber 54.

The operation of laser system 1A is now described for the scenario in which optical fiber 2 includes core 14, cladding layers 16A and 16B extending continuously through chamber 54/jacket 20 and cladding layer 16C segments 30 and 32. Pump source(s) 6 may produce pump light which may exit (Arrows B) pump source 6 and pass downstream through lens 110 to enter the optical cavity comprising reflector 106, fiber 2 and reflector 108 to produce laser (Arrow G) which exits output/reflector 108.

More particularly, in addition to the pump light that exits pump source(s) 6 and enters layer 16A as discussed above, the pump light that exits pump source(s) 6 may pass downstream through lens 110 or another such lens and enter upstream end 26 of cladding layer 16B and travel downstream through layer 16B so that a portion of the pump light in layer 16B may move from layer 16B into layer 16A and may be absorbed in the gain medium or core 14 to help produce laser G. Unused or unabsorbed pump light not absorbed in the gain medium or fiber 2 may also move downstream through layer 16B to exit the output/reflector 108 of the optical cavity/oscillator (Arrows C).

As pump light moves through cladding layer 16B, it may be reflected back and forth initially upstream of jacket 20 end wall 56 at or along the boundary or interface of layer 16B and layer 16C upstream segment 30 where outer perimeter 46 of layer 16B and inner perimeter 48 of layer 16C upstream segment 30 meet, then inside interior chamber 54/jacket 20 at or along the boundary or interface of solid layer 16B and liquid layer 18 where outer perimeter 46 of layer 16B and the inner perimeter of liquid layer 18 meet, then downstream of jacket 20 end wall 58 at or along the boundary or interface of layer 16B and layer 16C downstream segment 32 where outer perimeter 46 of layer 16B and inner perimeter 48 of layer 16C downstream segment 32 meet.

The heat exchange operation may be the same as described above with respect to system 1 when optical fiber 2 includes core 14, cladding layers 16A and 16B, and cladding layer 16C segments 30 and 32 such that outer perimeter 42 of layer 16B is exposed to liquid layer 18 inside chamber 54.

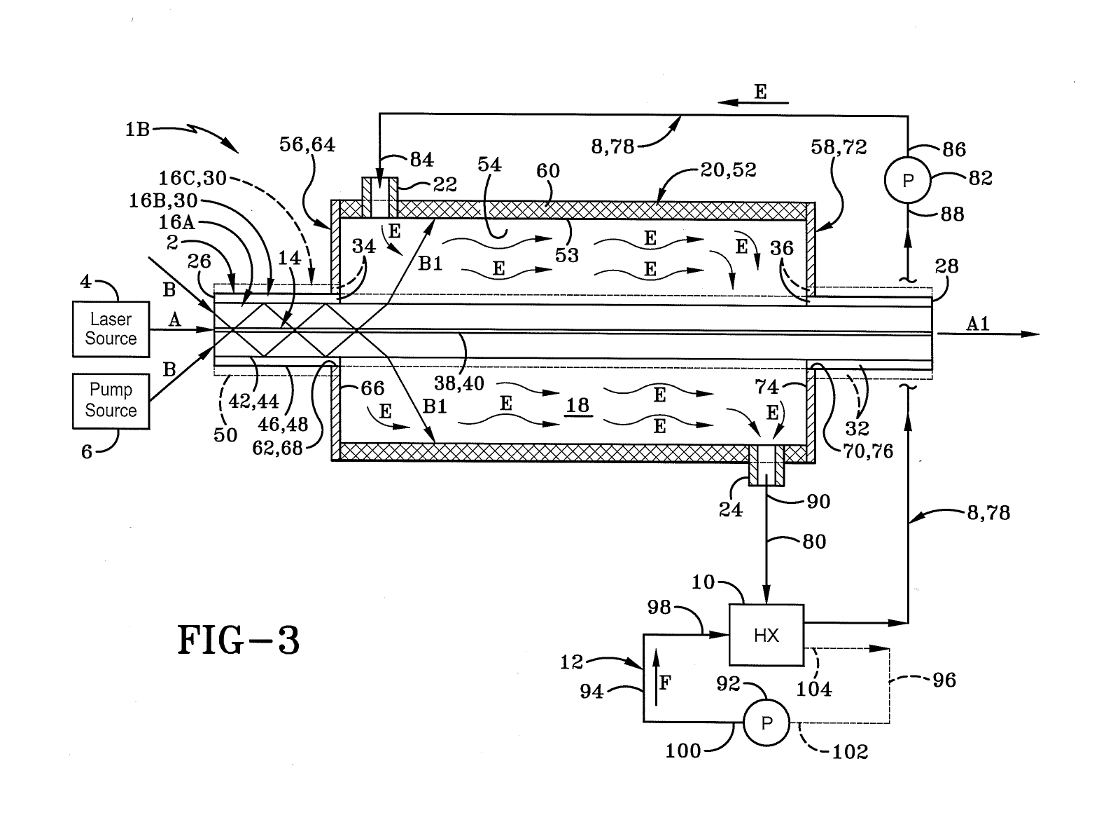

System 1B shown in FIG. 3 may be the same as system 1 shown in FIG. 1 except that liquid cladding layer 18 may have a refractive index which is more than or higher than the refractive index of the solid cladding layer 16 which is the outermost of the solid cladding layers 16 of optical fiber 2 which is inside interior chamber 54/jacket 20 so that the outer perimeter of the outermost layer 16 inside interior chamber 54/jacket 20 is in contact with liquid cladding layer 18. Thus, for instance, where optical fiber 2 includes layer 16A extending inside/through interior chamber 54/jacket 20 and outside (upstream and downstream) of interior chamber 54/jacket 20, and includes layer 16B segment 30 upstream of and outside interior chamber 54/jacket 20 and layer 16B segment 32 downstream of and outside interior chamber 54/jacket 20, liquid cladding layer 18 is in contact with outer perimeter 42 of layer 16A and has a refractive index which is higher than the refractive index of layer 16A. By way of further example, where optical fiber 2 includes layers 16A and 16B extending inside/through interior chamber 54/jacket 20 and outside (upstream and downstream) of interior chamber 54/jacket 20, and includes layer 16C segment 30 upstream of and outside interior chamber 54/jacket 20 and layer 16C segment 32 downstream of and outside interior chamber 54/jacket 20, liquid cladding layer 18 is in contact with outer perimeter 46 of layer 16B and has a refractive index which is higher than the refractive index of layer 16B.

Thus, of the core 14 and the cladding layers 16 and 18 which are used in optical fiber 2, core 14 may have the highest refractive index, the refractive indexes or indices of the cladding layers 16 may be sequentially less or lower as one moves radially outward further from core 14, and liquid cladding layer 18 may have a refractive index which is higher than that of the outermost solid cladding layer 16 which is inside chamber 54 and extends continuously from the upstream end or end wall 56 of chamber 54/jacket 20 to the downstream end or end wall 58 of chamber 54/jacket 20.

The operation of system 1B may be similar to system 1 with respect to the heat exchange described above. However, the use of the “high index” fluid 18 in system 1B changes the operation of laser/light propagation. The operation of laser system 1B is now described for the scenario in which optical fiber 2 includes core 14, cladding layer 16A and cladding layer 16B segments 30 and 32. Laser source 4 may produce a seed laser (Arrow A) which exits laser source 4 and enters upstream end 26 of core 14 and travels downstream through core 14 to and out of downstream end 28 of core 14.

Meanwhile, pump source(s) 6 may produce pump light which, as represented at Arrows B, exits pump source 6 and may enter upstream end 26 of cladding layer 16A and travel downstream through layer 16A so that a portion of the pump light is absorbed in the gain medium or core 14 to amplify the seed laser (Arrow A) to produce an amplified laser which exits the downstream end 28 of core 14, as represented at Arrow A1. However, instead of any unabsorbed or unused portion of the pump light which is not absorbed by the core 14 continuing to travel downstream through layer 16A to exit downstream end 28 of layer 16A, as was the case with system 1, the unabsorbed light or cladding mode is removed through the higher index liquid cladding layer 18 inside chamber 54.

More particularly, as the pump light moves through cladding layer 16A, it may be reflected back and forth initially upstream of jacket 20 end wall 56 at or along the boundary or interface of layer 16A and layer 16B upstream segment 30 where outer perimeter 42 of layer 16A and inner perimeter 44 of 16B upstream segment 30 meet. However, the pump light/cladding mode which continues further downstream to move into chamber 54 moves through layer 16A until it meets layer 18, through which the pump light/cladding mode moves (Arrows B1) and intersects the jacket 20 chamber wall 52, which may be an optical absorber which absorbs the pump light/cladding mode. System 1B may thus serve as a pump remover or cladding mode stripper so that the unused pump light or cladding mode within layer 16A does not enter the portion of layer 16A which is downstream of end wall 58 and does not exit chamber 54/jacket 20 via layer 16A/downstream end 28. It may also be said that layer 18 may serve as an anti-waveguide around the solid cladding layer(s) of fiber 2, whereby system 1B may thus provide a pump remover or cladding mode stripper to remove any remaining pump radiation which is propagating in the solid cladding layer(s) and any leaked core radiation which leaks out from core 14 through the solid cladding layer(s). This radiation may be absorbed in the optical absorber of jacket wall 52 and converted to heat.

The operation of laser system 1B is now briefly described for the scenario in which optical fiber 2 includes core 14, cladding layer 16A, cladding layer 16B which extends all the way through chamber 54/jacket 20, and cladding layer 16C segments 30 and 32, although one skilled in the art should understand this operation without further explanation. Laser source 4 and pump source(s) 6 may operation in the same manner with respect to core 14 and layer 16A. In addition, pump light from pump source(s) 6 may (Arrows B) exit pump source 6 and enter upstream end 26 of cladding layer 16B and travel downstream through layer 16B so that a portion of the pump light may enter layer 16A and be absorbed in the gain medium or core 14 to amplify the seed laser (Arrow A) to produce an amplified laser which exits the downstream end 28 of core 14, as represented at Arrow A1. However, instead of any unabsorbed or unused portion of the pump light which is not absorbed by the core 14 continuing to travel downstream through layer 16B to exit downstream end 28 of layer 16B, as was the case with system 1, the unabsorbed light or cladding mode is removed from layer 16B through the higher index liquid cladding layer 18 inside chamber 54.

More particularly, as the pump light moves through cladding layer 16B, it may be reflected back and forth initially upstream of jacket 20 end wall 56 at or along the boundary or interface of layer 16B and layer 16C upstream segment 30 where outer perimeter 46 of layer 16B and inner perimeter 48 of 16C upstream segment 30 meet. However, the pump light/cladding mode which continues further downstream to move into chamber 54 moves through layer 16B until it meets layer 18, through which the pump light/cladding mode moves (Arrows B1) and intersects the jacket 20 chamber wall 52, which may be an optical absorber which absorbs the pump light/cladding mode. System 1B may thus serve as a pump remover or cladding mode stripper so that the unused pump light or cladding mode within layer 16B does not enter the portion of layer 16B which is downstream of end wall 58 and does not exit chamber 54/jacket 20 via layer 16B/downstream end 28.

It will be understood that various components of any given laser system shown in the Figures may be upstream of or downstream of other components of the given laser system, and that in the present application, it is generally true that with respect to the optical components of the given laser system through which light (laser/pump light) may pass (e.g., laser source 4, optical pump source 6, optical fiber 2, jacket 20, lens 110, high reflector mirror 106, partial reflector mirror 108), any such optical component, portion or surface of a given optical component and so forth shown to the left of one or more of such components, portions, surfaces, etc. of a given laser system may be upstream of said one or more such components, etc. and that any such component, etc. shown to the right of one or more other such components, etc. of a given laser system may be downstream of said one or more other such components, etc.

It will also be understood that the various components of a given laser system discussed herein are in the optical communication with one another such that light or a laser may move or propagate (downstream) from one component of the given system to the other components of the given system. Thus, for instance, with respect to laser system 1 of FIG. 1 and system 1B of FIG. 3, core 14 may be downstream of and in optical communication with laser source 4; layers 16A and 16B may be downstream of and in optical communication with pump source(s) 6; and core 14, layer 16A, liquid layer 18, layer 16B segments 30 and 32 (or continuous layer 16B and layer 16C segments 30 and 32 where used) may be in optical communication with one another. In addition to (or overlapping with) the above-noted aspects which are likewise true about system 1A as evident from FIG. 2, mirror 106 may be downstream of and in optical communication with pump source 6 and lens 110; oscillator fiber 2 of the oscillator may be downstream of and in optical communication with mirror 106, lens 110 and pump source 6; and mirror 108 may be downstream of and in optical communication with fiber 2 of the oscillator, mirror 106, lens 110 and pump source 6.

It is noted that various components or terms having the same names described herein may be denoted as additional or other components, or first, second, third and fourth components, etc. For instance, various cladding layers may be denoted as an additional cladding layer or another cladding layer or first, second, third, fourth, (etc) cladding layers, and so forth. Other such components may include, without limitation, refractive indexes or indices, upstream ends, downstream ends, inner perimeters, outer perimeters, inlets, outlets, feed lines or conduits, discharge lines or conduits, end walls, holes and so forth. Similarly, various similar components, etc. may be referred to as an upstream component, etc. or downstream component, etc. where applicable.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration set out herein are an example not limited to the exact details shown or described.

1. A laser system comprising:
an optical fiber comprising a rare earth doped core, at least one solid cladding layer, a liquid cladding layer which is formed of a liquid and which extends around and is in contact with the at least one solid cladding layer, and a jacket defining an interior chamber which contains the liquid cladding layer.

2. The system of claim 1 wherein the jacket has a jacket inlet and a jacket outlet each in fluid communication with the interior chamber; and the liquid is flowable into the interior chamber through the jacket inlet and flowable out of the interior chamber through the jacket outlet.

3. The system of claim 2 further comprising a feed line connected to the jacket inlet; and a discharge line connected to the jacket outlet.

4. The system of claim 1 further comprising a first closed circulation loop which comprises the interior chamber; and a heat exchanger which is outside the jacket and adjacent the first circulation loop so that heat is transferable from the liquid to the heat exchanger.

5. The system of claim 4 further comprising a second closed circulation loop which extends adjacent the heat exchanger.

6. The system of claim 4 further comprising a flow path which extends adjacent the heat exchanger; and a pump or blower in fluid communication with the flow path.

7. The system of claim 1 wherein the at least one solid cladding layer comprises (a) a first solid cladding layer having a first solid cladding layer internal segment extending inside the jacket and a first solid cladding layer external segment extending outside the jacket and (b) a second solid cladding layer having a second solid cladding layer external segment extending outside the jacket;
the first solid cladding layer external segment is embedded in the second solid cladding layer external segment; and
the liquid cladding layer is in contact with the first solid cladding layer internal segment.

8. The system of claim 7 wherein the first solid cladding layer external segment is a first solid cladding layer upstream external segment which extends upstream of the jacket;
the second solid cladding layer external segment is a second solid cladding layer upstream external segment which extends upstream of the jacket;
the first solid cladding layer has a first solid cladding layer downstream external segment which extends downstream of the jacket;
the second solid cladding layer has a second solid cladding layer downstream external segment which extends downstream of the jacket; and
the first solid cladding layer downstream external segment is embedded in the second solid cladding layer downstream external segment.

9. The system of claim 1 wherein the at least one solid cladding layer comprises a first solid cladding layer which has a first refractive index; and the liquid cladding layer is in contact with the first solid cladding layer and has a second refractive index less than the first refractive index.

10. The system of claim 1 wherein the at least one solid cladding layer comprises a first solid cladding layer which has a first refractive index; and the liquid cladding layer is in contact with the first solid cladding layer and has a second refractive index greater than the first refractive index.

11. The system of claim 10 wherein a portion of the jacket serves as an optical absorber adapted for absorbing cladding mode.

12. A method comprising the steps of:
providing an optical fiber comprising a rare earth doped core, at least one solid cladding layer, a liquid cladding layer which is formed of a liquid and which extends around and is in contact with the at least one solid cladding layer, and a jacket defining an interior chamber which contains the liquid cladding layer; and
pumping pump light into the at least one solid cladding layer.

13. The method of claim 12 further comprising the step of circulating the liquid into and out of the interior chamber.

14. The method of claim 13 wherein the step of circulating comprises circulating the liquid through a heat exchanger which is outside the jacket.

15. The method of claim 14 wherein the liquid is a heated liquid upon entering the heat exchanger; and further comprising the step of moving a cooling gas or cooling liquid along a flow path adjacent the heat exchanger so that heat is transferred from the heated liquid to the cooling gas or cooling liquid.

16. The method of claim 12 further comprising the step of seeding the core with a seed laser.

17. The method of claim 12 wherein the optical fiber is part of an optical fiber oscillator; and the step of pumping results in creation of a laser in the core.

18. The method of claim 12 wherein the at least one solid cladding layer comprises a first solid cladding layer which has a first refractive index; and the liquid cladding layer is in contact with the first solid cladding layer and has a second refractive index less than the first refractive index; and further comprising the step of amplifying a laser in the core with pump light within the interior chamber.

19. The method of claim 12 wherein the at least one solid cladding layer comprises a first solid cladding layer which has a first refractive index; and the liquid cladding layer is in contact with the first solid cladding layer and has a second refractive index greater than the first refractive index; and further comprising the step of removing the pump light from the first solid cladding layer via the liquid cladding layer.

20. The method of claim 19 further comprising the step of absorbing the removed pump light with a portion of the jacket.
